(19) United States
(12) Patent Application Publication
(10) Pub. No.: US 2004/0064451 A1
(43) Pub. Date: Apr. 1, 2004

(54) Method for sorting permutations with reversals

(76) Inventors: Kathleen Mary Kaplan, Arlington, VA (US); John Jacob Kaplan, Middletown, NJ (US)

Correspondence Address: Kathleen Mary Kaplan, 3800 North Fairfax Drive #1808, Arlington, VA, 22203, US

(21) Appl. No.: 10/134,548

(22) Filed: Sep. 27, 2002

(51) Int. Cl. G06F 17/30

(52) U.S. Cl. 707/7

(57) ABSTRACT

A method for sorting permutations using reversals for matching genomic evolution or other permutations. The sorting method includes steps to set up a data structure for storing the permutations, assigning symbols to match the permutation elements, and isolate the contiguous sections within the data structure. The corresponding sections are then reversed and the symbols changed in order to sort the permutations recursively until all symbols are contiguous.

There are no related applications.

The invention was not supported by Federally sponsored research and development.

### FIELD OF THE INVENTION

The invention generally relates to the field of computer science, wherein reversals can be used for sorting. Specifically, this invention can be used in the field of computational biology, wherein reversals are used to detect the evolution of genomes.

### BACKGROUND OF THE INVENTION

1. Related Art

As organisms evolve, the genetic material of the organisms change. Genomes frequently evolve by reversals that transform a gene order, represented by signed permutations, of one signed permutation to another signed permutation. Sturtevant and Dobzhansky [A. H. Sturtevant and T. Dobzhansky, “Inversions in the third chromosome of wild races of drosophila pseudoobscura, and their use in the study of the history of species,” Proc. Nat. Acad. Sci. 22, 1936, pages 448-450] analyzed genome rearrangements and found seventeen inversions between the species of drosophila (fruit fly).

The combinatorial problem of sorting by signed permutations was discussed by Hannanhalli and Pevzner [S. Hannanhalli and P. Pevzner. Transforming cabbage into turnip (polynomial algorithm for sorting signed permutations by reversals). Proceedings of the 27th Annual ACM Symposium on the Theory of Computing, pages 178-189, 1995]. Pevzner discusses sorting by signed permutations in other papers [V. Bafna and P. Pevzner. Genome rearrangements and sorting by reversals. SIAM Journal on Computing, 25(2):272-289, 1996][S. Hannenhalli and P. Pevzner. Transforming men into mice (polynomial algorithm for genomic distance problem). Proceedings of the IEEE 36th Annual Symposium on Foundations of Computer Science, pages 581-592, 1995]. A method based on Pevzner's work was presented recently at the RECOMB 2002 6th Annual International Conference on Computational Biology by Siepel [A. Siepel. An algorithm to find all sorting reversals. RECOMB '02 ACM, pages 281-290, 2002]. A good discussion of current genome rearrangements can be found in [J. Setubal and J. Meidanis. Introduction to Computational Biology. PWS Publishing Company, pages 215-244, 1997].

The current methods used to sort signed permutations require preparation to find cycles, hurdles, and fortresses whereas the invention presented requires no a priori information other than the signed permutations themselves. The presented invention requires less computational time than the other methods in the parallel case.

### SUMMARY OF THE INVENTION

The invention is a sorting method. The sorting method includes the steps of obtaining and storing signed or unsigned permutations in a data structure within a general purpose computer. Different symbols are then assigned to each intersection of the same and signed (or unsigned) permutations within the data structure. Next, the elements corresponding to indices or elements on diagonals within the data structure are traversed to find contiguous sections of symbols. The contiguous sections are then reordered when the continuous sections contain at least two symbols where at least one symbol is not the desired symbol. Reordering involves reversing the order of the indices and changing the sign of these reordered indices. The symbols are then changed to other symbols. The previous steps are then continued until all symbols are contiguous. A final reordering may be necessary.

### FEATURES AND ADVANTAGES

The method sorts a data structure based on reversals.

The method precludes the use of hurdles, cycles, fortresses and complex graph theory as used in existing sorting methods based on reversals.

The method has a lower-bound time complexity of O(n) and sorts faster than current methods because the method steps can be completed in a highly parallel fashion.

Additionally, the method does not require any pre-sorting preparation.

### BRIEF DESCRIPTION OF THE DRAWINGS

The present invention is described with reference to the accompanying drawings. In the drawings, like reference numbers indicate identical or functionally similar elements. Additionally, the left-most digit of a reference number identifies the drawing in which the reference number first appears.

FIG. 1 shows a flow chart of the sorting method.

FIG. 2 shows an example.

### DETAILED DESCRIPTION

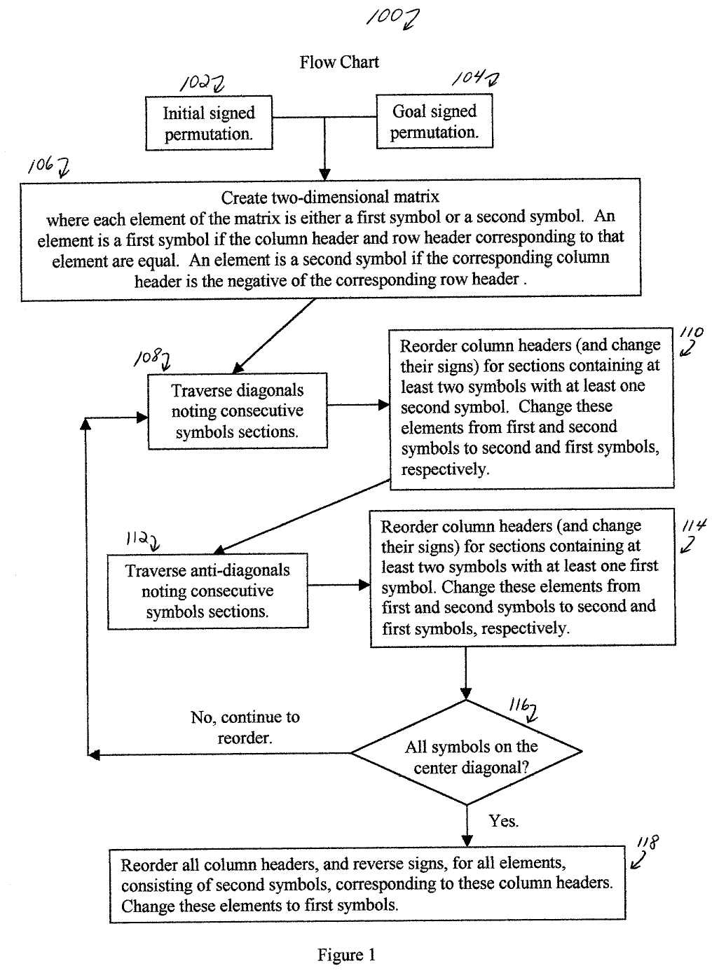

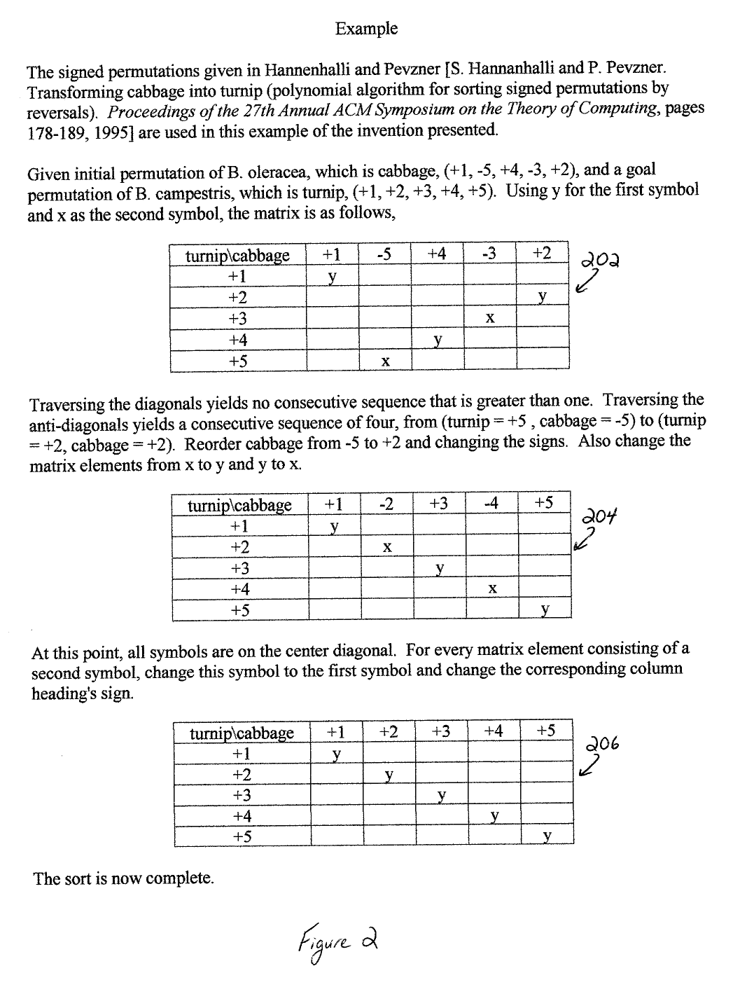

The invention is a sorting method using reversals. The invention provides steps to sort permutations using reversals. A method to sort permutations using reversals is perfectly suited for matching genomic evolution. The sorting method using reversals is described in detail with reference to FIGS. 1 and 2.

FIG. 1 is a flow chart of an embodiment of the sorting method using reversals. The sorting method operates in a computer such as a personal computer or a parallel computer cluster or a supercomputer. The sorting method includes initial steps 102 and 104 for inputting two signed permutations into a computer. After the permutations are stored in a computer, step 106 creates a two-dimensional matrix where the column headers correspond to permutation of step 102 and the row headers correspond to permutation of step 104. Column headers and row headers are examples of indices. A first symbol such as y is placed in all the matrix elements when the column header and the row header are equal and have the same sign. A second symbol such as x is placed in all the matrix elements when the column header and the row header are equal with different signs. The matrix element is left blank or assigned a third symbol when the column header is not equal to the row header. After the matrix elements are determined, step 108 traverses each diagonal noting the consecutive symbol sections. Step 110 then reorders the matrix column headers for sections containing at least two symbols with at least one second symbol. Reordering involves reversing the present order and changing the signs of the column headers of the said sections. Thereafter, change the matrix elements corresponding to the sections from first and second symbols to second and first symbols, respectively. Next, in step 112 traverse each anti-diagonal, wherein an anti-diagonal is a diagonal of slope negative one, noting the consecutive symbol anti-sections. Anti-sections are sections of consecutive symbols that are located on an anti-diagonal. These anti-sections are defined by their corresponding indices. Step 114 then reorders the matrix column headers for each section containing at least two symbols with one first symbol. Change the matrix elements for each section containing at least two symbols with one first symbol from first and second symbols to second and first symbols, respectively. In step 11 6, if all symbols are not on the center diagonal of the matrix, then repeat steps 108 through 116 but if all symbols are on the center diagonal, then go to step 118. In step 118, reorder all matrix elements consisting of second symbols. Then change these matrix elements to first symbols. The sorting method results in a viable sort with respect to reversals.

FIG. 2 is a detailed example of the sorting method with reversals using a permutation of cabbage and turnip. This example uses y as the first symbol and x as the second symbol. The initial permutation is (+1, −5, +4, −3, +2) and the goal permutation is (+1, +2, +3, +4, +5). The resulting matrix 202 shows the initial and goal permutations as the column header elements and the row header elements respectively. Matrix 202 shows step 106 in placing the first symbol, y, and the second symbol, x, in Matrix 202. Traversing the diagonals yields no consecutive sequence that is greater than one so the method skips step 110 and moves to step 112. In step 112, the anti-diagonals are traversed yielding a consequence section from turnip, cabbage (+5, −5) to turnip, cabbage (+2, −2). The matrix is then reordered from −5 to +2 and the signs on the column header elements are changed to the opposite signs and the symbols are changed from x to y and y to x respectively. The resulting matrix is shown as matrix 204. This matrix has all symbols on the center diagonal. Next, change each second symbol x to first symbol y and reorder all column headers of these changed symbol sections. Matrix 206 is the resulting sorted matrix.

An alternative embodiment of the sorting method includes traversing all diagonals and anti-diagonals in parallel by using a parallel processor. In other words, traversing all diagonals within step 108 can be performed in parallel, traversing all diagonals within step 112 can be performed in parallel, and completing steps 108 and 112 can be performed in parallel. Additionally, many other embodiments of the sorting method can be practiced by using various data structures.

The computational time complexity for this method ranges from n, where n is the number of elements in a permutation, to n*n. The lower bound is much smaller than current methods.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

I claim:

1. A method for sorting signed permutations by reversals in a general purpose computer, comprising the steps of:
(a) store multiple unsigned permutations as data structure indices elements in a data structure;
(b) said data structure is comprised of elements corresponding to the intersection of each data structure indices header element;
(c) assign a symbol to each said data structure indices element where said data structure indices header element is equal to data structure indices header element;
(d) transverse the indices of said data structure to find contiguous indices of said symbols;

2. A method for sorting signed permutations by reversals in a general purpose computer, comprising the steps of:
(a) store multiple signed permutations as signed data structure indices elements in a data structure;
(b) said data structure is comprised of elements corresponding to the intersection of each data structure indices header element;
(c) assign a first symbol to each said data structure indices element where said data structure indices header element is equal to and same sign as said different data structure indices header element;
(d) assign a second symbol to each said data structure element where said data structure column header element is equal to and different sign as said data structure row header element;
(e) transverse the indices of said data structure to find contiguous indices of said first and said second symbols;
(f) reorder said indices header elements of said contiguous indices in reverse order when said contiguous indices contains at least two symbols where at least one symbol is said second symbol and change each said data structure element in said contiguous indices from said first symbol and said second symbol to said second symbol and said first symbol, respectively;
(g) continue steps (e) through (f) until all said first and all said second symbols are elements of said indices;
(h) change all said second symbols to said first symbols in said indices and change sign of corresponding said data structure column header elements.

3. A method for sorting signed permutations by reversals in a general purpose computer, comprising the steps of:
(a) obtain signed permutations;
(b) store signed permutations as signed indices in a data structure;
(c) said data structure is comprised of elements corresponding to the intersection of each element of one indices with each and every element of all the other indices;
(e) assign a first symbol to each said indices where said elements of said indices are equal to and same sign as corresponding elements of corresponding other indices;
(f) assign a second symbol to each said indices where said elements of said indices are equal to and different sign as corresponding elements of corresponding other indices;
(g) transverse the indices of said data structures to find contiguous indices sections of said first and said second symbols;
(h) reorder said indices elements of said contiguous indices section in reverse order when said contiguous indices section contains at least two symbols where at least one symbol is said second symbol and change each said data structure element in said contiguous indices section from said first symbol and said second symbol to said second symbol and said first symbol, respectively;
(i) transverse the anti-indices of said data structure to find contiguous anti-indices of said first and said second symbols;
(j) reorder said indices elements of said contiguous indices anti-sections in reverse order when said contiguous indices anti-section contains at least two symbols where at least one symbol is said first symbol and change each said data structure element in said contiguous indices anti-section from said first symbol and said second symbol to said second symbol and said first symbol, respectively
(k) continue steps (g) through (j) until all said first and all said second symbols are elements of said indices;
(l) change all said second symbols to said first symbols on said indices and change sign of corresponding said indices header elements.

4. A method for sorting signed permutations by reversals in a general purpose computer, comprising the steps of:
(a) store two signed permutations as signed row headers and signed column headers in a data structure;
(b) said data structure is comprised of elements corresponding to the intersection of each data structure element;
(c) assign a first symbol to each said data structure element where said data structure column header element is equal to and same sign as said data structure row header element;
(d) assign a second symbol to each said data structure element where said data structure column header element is equal to and different sign as said data structure row header element;
(e) transverse the indices of said data structure to find contiguous indices of said first and said second symbols;
(f) reorder said column header elements of said contiguous indices in reverse order when said contiguous indices contains at least two symbols where at least one symbol is said second symbol and change each said data structure element in said contiguous indices from said first symbol and said second symbol to said second symbol and said first symbol, respectively;
(g) continue steps (e) through (f) until all said first and all said second symbols are elements of said indices;
(h) change all said second symbols to said first symbols in said indices and change sign of corresponding said data structure column header elements.

5. A method for sorting signed permutations by reversals in a general purpose computer, comprising the steps of:
(a) store two signed permutations as signed row headers and signed column headers in a two dimensional matrix;
(b) said matrix is comprised of elements corresponding to the intersection of each element of said column headers with each element of said row headers such that each column intersects with all row elements;
(c) assign a first symbol to each said matrix element where said column header element is equal to and same sign as said row header element;
(d) assign a second symbol to each said matrix element where said column header element is equal to and different sign as said row header element; p1 (e) transverse the diagonals of said two dimensional matrix to find contiguous sections of said first and said second symbols;
(f) reorder said column header elements of said contiguous sections in reverse order when said contiguous section contains at least two symbols where at least one symbol is said second symbol and change each said matrix element in said contiguous section from said first symbol and said second symbol to said second symbol and said first symbol, respectively;
(g) continue steps (e) through (f) until all said first and all said second symbols are elements of said diagonal;
(h) change all said second symbols to said first symbols on said diagonal and change sign of corresponding said column header elements.

6. A method for sorting signed permutations by reversals in a general purpose computer, comprising the steps of:
(a) obtain an initial signed permutation and a goal signed permutation;
(b) store said initial signed permutation as signed column headers in a two dimensional matrix;
(c) store said goal signed permutation as signed row headers in said two dimensional matrix in general purpose computer;
(d) said matrix is comprised of elements corresponding to the intersection of each element of said column headers with each element of said row headers such that each column intersects with all row elements;
(e) assign a first symbol to each said matrix element where said column header element is equal to and same sign as said row header element;
(f) assign a second symbol to each said matrix element where said column header element is equal to and different sign as said row header element;
(g) transverse the diagonals of said two dimensional matrix to find contiguous sections of said first and said second symbols;
(h) reorder said column header elements of said contiguous sections in reverse order when said contiguous section contains at least two symbols where at least one symbol is said second symbol and change each said matrix element in said contiguous section from said first symbol and said second symbol to said second symbol and said first symbol, respectively;
(i) transverse the anti-diagonals of said two dimensional matrix to find contiguous anti-sections of said first and said second symbols;
(j) reorder said column header elements of said contiguous anti-sections in reverse order when said contiguous anti-section contains at least two symbols where at least one symbol is said first symbol and change each said matrix element in said contiguous anti-section from said first symbol and said second symbol to said second symbol and said first symbol, respectively
(k) continue steps (g) through (j) until all said first and all said second symbols are elements of said diagonal;
(l) change all said second symbols to said first symbols on said diagonal and change sign of corresponding said column header elements.

7. A method of claim 1 wherein the step of transversing said indices is completely in parallel using a parallel computer.

8. A method of claim 2 wherein the step of transversing said indices is completely in parallel using a parallel computer.

9. A method of claim 3 wherein the step of transversing said indices and said anti-indices is completely in parallel using a parallel computer.

10. A method of claim 4 wherein the step of transversing the indices is completely in parallel using a parallel computer.

11. A method of claim 5 wherein the step of transversing said diagonals is completely in parallel using a parallel computer.

12. A method of claim 6 wherein the step of transversing said diagonals and said anti-diagonals is completely in parallel using a parallel computer.
